(19) United States
(12) Patent Application Publication
(10) Pub. No.: US 2010/0201491 A1
(43) Pub. Date: Aug. 12, 2010

(54) DEVICE FOR TRACKING RENTED BOWLING SHOES

(76) Inventor: Alain jean-pierre Jacot, Bussy Saint Martin (FR)

Correspondence Address: Charles Muserlain, 317 Bliss Lane, Valley Cottage, NY, 10989, US

(21) Appl. No.: 12/450,033

(22) PCT Filed: Mar. 6, 2008
(86) PCT No.: PCT/FR2008/000296

§ 371 Date: Feb. 22, 2010

(30) Foreign Application Priority Data
Mar. 7, 2007 (FR) 0701642
Mar. 5, 2008 (FR) 0801215

(51) Int. Cl. H04Q 5/22

(52) U.S. Cl. 340/10.1

(57) ABSTRACT

The invention relates to a tracking device for managing the rental of a stock of bowling shoes including a stock of shoes for rent and arranged inside a rental space, characterized in that at least one shoe of each pair of shoes is provided with an active RFID chip for transmission to a reception antenna located inside the rental space and connected in such a manner with the reader and the processing computer of the rental space that the presence of pairs of shoes can be monitored in real time when they are not rented out, and in that it further comprises means for deactivating the transmission of the active RFID chips and/or the reception by the antenna when the shoes are rented out in such a manner that the absence of pairs of shoes inside the rental space can be continuously monitored.

The present invention relates to a device for tracking rented bowling shoes. The invention contributes significant progress both to real time monitoring of rented equipment as well as to improved management of the history and forecasting the stock of shoes. The invention has application in the monitoring of other rental equipment, such as the rental of tennis rackets, golf clubs or ice skates.

The manner in which rental shoes are currently managed in an enclosure like bowling alleys presents numerous disadvantages that the invention proposes to resolve. Bowling customers first pay for access to the bowling lanes. When they have right to this access, they must show that they are wearing special shoes whose soles are suitable for bowling. Some experienced customers have their own shoes that comply with the standards. However, a large part of customers must rent their shoes. To meet demand bowling alleys currently must manage a stock of several hundred pairs of shoes. In some bowling alleys, this space is free of cost and can be accessed freely by users. In other bowling alleys, this rental space is managed by personnel who perform the following series of tasks: 1—Collect the payment or payment ticket; 2—Furnish a pair of bowling shoes of the appropriate size; 3—Store the user's street shoes; and 4—Finally, take back the bowling shoes and return the customer's street shoes. At the present time, some users, either maliciously or absent-mindedly leave the bowling alley leaving behind their old street shoes. This represents a financial loss for the bowling alley which must then purchase a new pair of bowling shoes, and which certainly cannot make any money on the old street shoes. In another aspect, the new non-smoking laws in effect in many countries require bowlers wearing bowling shoes to leave the bowling alley in order to smoke outside. This has numerous disadvantages: first, the use of bowling shoes on an unsuitable surface deteriorates the soles of the shoes, then returning to the play area with the bowling shoes does long-term damage, and finally, this makes the bowling parties longer because of having to wait for a player who smokes. This new problem represents a significant loss of money and requires large investments in shoes and bowling lanes. As of today, there has been no solution to this problem. It can also occur that the personnel does the renting but keeps the collected money for himself. It is currently impossible to prove this small-time fraud by personnel.

Currently in a bowling alley, the collection desk for shoe rental is independent of the entry collection desk, as with the bar and for the collection for bowling lanes. The invention thus seeks to improve the management of this shoe rental desk. The invention proposes an original and innovative approach, which is to determine a rental space, continuously locate pairs of shoes present in said rental space and record the departure of pairs of shoes from said rental space. The invention continuously measures the stock present in the rental space and verifies that the stock that leaves is either properly accounted for or declared obsolete. There are already solutions developed for tracking the stock of rental shoes. All of the existing solutions have a different approach than rental management. Numerous patents propose solutions with passive RFID type technologies and with reader of transmitter badges or transmitter gantries. For example, there is a patent JP 2005 278791 that describes tracking patients in a hospital from a passive RFID type chip, coupled with badge reader systems in the floor. There is US patent 2006/0097847 concerning the identification of sport shoes by means of coupling a passive RFID chip and clearly defined short-range detection zones. Also, patents WITHOUT 0182235 and DE 19644035 propose identification systems for ski rental based on a passive RFID with activation by passing in front of a reader. Finally, more specifically, patent DE 10131066 more particularly targets the problem of managing the rental of bowling shoes by proposing a passive RFID type technology requiring activation when the shoe exits or at any other time. Furthermore, this patent DE 10131066 has several other defects that the invention proposes to resolve. Because the shoes are stored behind the rental counter, the counter must be transformed into a large RFID reader several meters or even dozens of meters long, resulting in a prohibitive cost. The patent proposes activating the chip upon leaving the compartment, thus requiring equipment for each compartment resulting in a prohibitive cost. This patent proposes to link the shoes to the customers, which cannot be done because the customers need to try on the shoes or even change them. This patent proposes to move or even add a detection zone near the lanes, which is impossible to accomplish because the player may need to leave the lanes.

The passive RFID requires the presence of gantries or detectors in the immediate proximity of which the chip has to pass. With the passive technology, the product is only detected when exiting or entering, in the immediate proximity of the gantry. Now, a malicious user or employee can quite transparently make the product go out then re-enter without passing near the gantry, thus swindling the management of the bowling alley. There is to date, therefore, no solution that is free of the limitations of proximity detection of the passive RFID and which allows the real time monitoring of a full stock of bowling shoes.

A principal object of the invention is to provide the bowling alley manager with a system for the real time management and tracking of the rental of bowling shoes. The invention seeks to work by detection volume on the rental space of the shoes and covers all shoes and compartments.

An object of the invention is to provide the bowling alley manager with a device for real time management and complete tracking, on the history and forecasts of the rental of bowling shoes.

An object of the invention is to provide the bowling alley manager with an improved tool for fighting fraud. The fraud can be by customers as well as personnel assigned to the rental of shoes.

An object of the invention is to prevent the use of the bowling shoes outside of reserved zones.

An object of the invention is to be integrated into the bowling alley simply and efficiently.

An object of the invention is to be integrated into and/or coupled with software for billing for the rental of shoes.

In one principal aspect, the invention comprises a device for tracking bowling shoes. Said tracking device is placed systematically in the sole of at least one of the shoes in each pair. This tracking device comprises the coupling of a chip laced in the sole of the shoe and a receiving system placed inside the rental enclosure of the bowling alley, making it possible to verify continuously and in real time the stock of shoes present in said zone. The invention consists of considering that the shoes have been rented when they leave said zone of the rental enclosure.

In one particular aspect, the chip is of the active RFID type, i.e. an RFID chip equipped with a battery that transmits continuously. Existing technologies allow transmissions of several dozen or even several hundred meters.

In one aspect, the receiver is placed in the storage unit for the shoes. The rental space for the shoes is thus especially designed to house a receiving antenna and the compartments for storing shoes are such that the signals transmitted by the shoes in their storage space are all received by the receiving antenna.

In one aspect, the invention seeks to capture only the signals from shoes that are not rented. As soon as a shoe is rented, the invention thus seeks either to stop the transmission of the transmitter signal from the active RFID chip, or to move the shoes away in such a manner that the receiving antenna no longer picks up the transmissions from the active RFID chips.

In one particular aspect, the shoes are of a special design that allows the transmission of the signal to be stopped as soon as they are put on by the user.

In one particular aspect, as soon as they are put on by the user the shoes continuously transmit a code called “rented.” Antennas are placed around the periphery of the bowling alley to detect this rented code. They are coupled with alarms that signal or thus block a customer from leaving having bowling shoes on his feet. The invention thus seeks to prevent the use of the bowling shoes outside of reserved zones.

In one improved aspect, the invention is coupled with an automated device like an automatic locker, which allows a perfectly reliable monitoring of the pickup and/or return of shoes. This variation makes it possible for the bowling alley manager to reduce his payroll for the shoe rental station. Because the management system is simple, it is totally transparent for the manager and employees of the bowling alley.

In one aspect of the invention, the bowling shoe is equipped with a dual control system, having one active RFID chip that makes it possible to detect leaving the rental space, and a passive RFID chip for validating, by an employee, a specific event in the life of the shoe by passing it beneath a specific gantry: entry into the stock, end of life of the shoe, loan, special rental.

The appended figures represent a particular embodiment of the invention, in which figures:

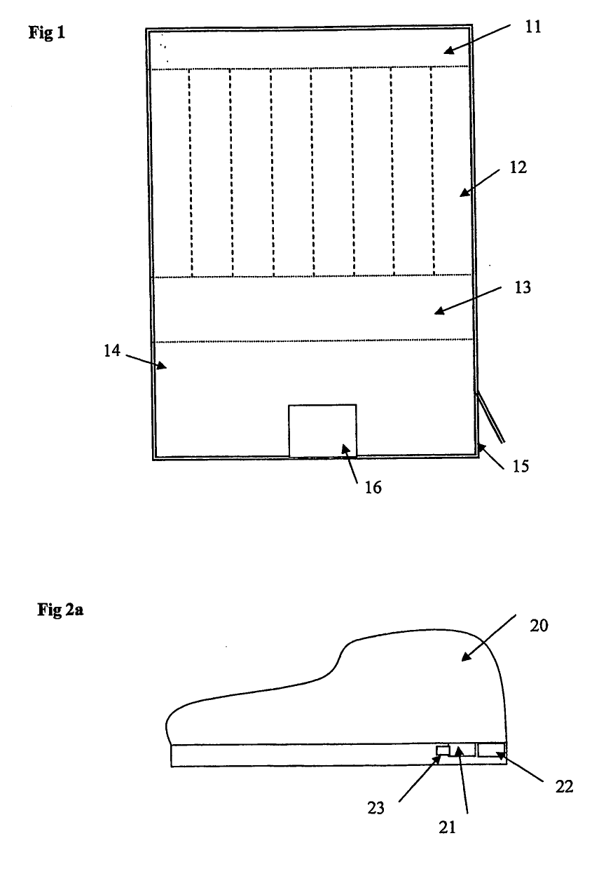

FIG. 1 represents a diagrammatic top view of a traditional bowling alley

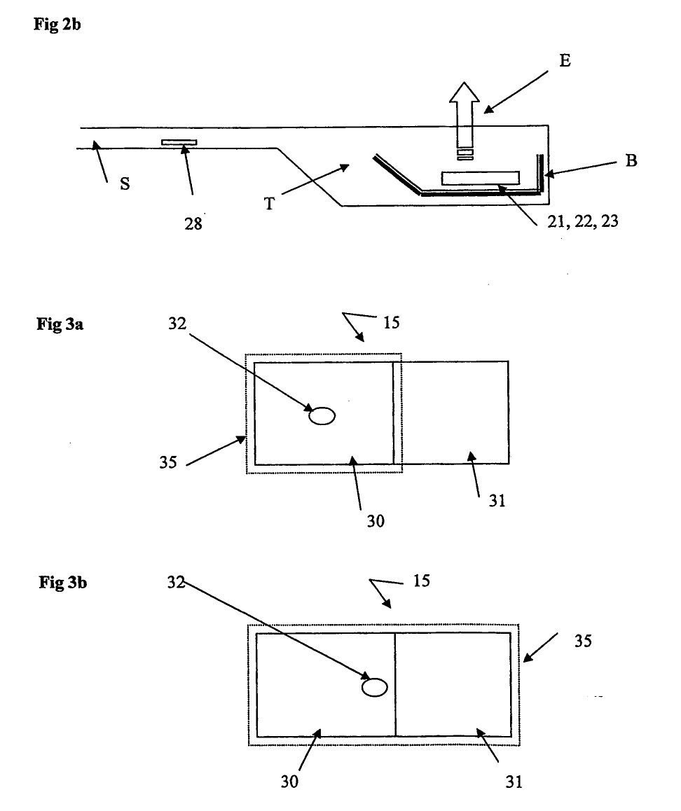

FIG. 2a represents a shoe according to the invention

FIG. 2b represents a shoe according to an improved form of the invention

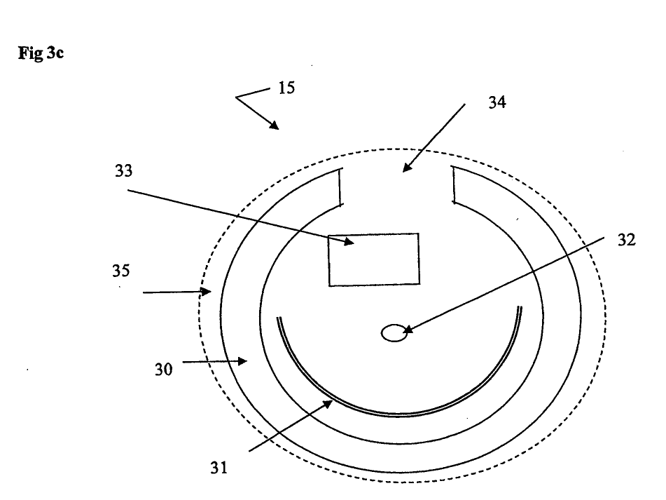

FIGS. 3a, 3b, 3c represent three set-ups of operation of the invention in the rental space of the shoes according to three different variations.

FIG. 1 represents a diagrammatic top view of a traditional bowling alley with its lanes (12), the pin setting mechanisms (11), the space for play and throwing the balls (13) called the approach, and the back room (14), which in particular includes the amenities, the bar, the rental space (15) and the entry (16). FIG. 2a represents a shoe (20) according to the invention which comprises an electronic chip (21) and a battery (22) that supplies it. The electronic chip (21) continuously transmits a UHF signal from its antenna (23). The unit formed by the electronic chip (21), battery (22) and antenna (23) constitutes the active RFID chip (21, 22, 23). As described in FIG. 3, the signal is then picked up or not by the receiving antennas (32) connected to a reader (33) which will decrypt the signal and transfer it to a computer. Commonly, the active RFID chip (21, 22, 23), called active RFID tag, is set to a UHF frequency of 433 or 868 MHz transmitting about every second. Its operating endurance is several years, depending on the type of battery and the nature of its parameterization. It range is several dozen meters. In a first variation of the invention, both shoes are equipped with an active RFID chip (21, 22, 23). In a second variation of the invention, only one of the pair of shoes is equipped with an active RFID chip (21, 22, 23). This second variation has the advantage of being more economical and simpler to manage by computer, but the slight disadvantage of having a small additional risk of a malicious act on one of the two shoes. FIG. 2b represents a shoe according to an improved embodiment of the invention which allows the transmission from the active RFID chip (21, 22, 23) to be cut off when it is worn by a user. The bowling shoe (20) houses in its heel (T) an active RFID chip (21, 22, 23). The invention seeks to channel all of the waves transmitted upward through the body of the user, and more specifically, into his heel. If the waves pass through the body of the user, the quality of the signal received by the receiving antenna is altered and the signal is no longer received. In order to channel the waves upward, a shield (B) is positioned in the heel beneath the active RFID chip. Another embodiment of the invention proposes to arrange a contact switch (28) in the sole (S) of the shoe (20). The function of the contact switch is either to block the transmission from the active RFID chip, or to make it transmit a different code called “rental,” when the foot is inserted inside the shoe. FIGS. 3a, 3b, 3c represent three schemas of operation of the invention in the shoes rental space. In a bowling alley, the shoe storage space (30) often includes several hundred pairs of shoes. Storage cabinets are therefore necessary. Near the storage space for the shoes is the space (31) for trying on the shoes. FIG. 3a represents a first case in which only the storage space is covered by the receiving antenna (32) in a zone called transmission zone (35). FIG. 3b represents a second case in which the receiving antenna (32) covers both the storage space (30) and the try-on space (31) contiguous thereto. FIG. 3c describes a situation in which the try-on space (31) is included in the storage space (30). In the case of each of FIGS. 3a, 3b, 3c the transmission zone (35) covers as much as possible of the usable storage area and possibly the try-on area. More particularly in FIG. 3c, in a very special configuration, the storage space 30 is arranged in an arc of circle. Seats in the try-on space (31) are positioned in a concentric arc of circle. At the center of this arc of circle is positioned the receiving antenna (32) of the active RFID chips. This receiving antenna (32) then communicates with the reader and the processing computer (33) which manages the rental space for bowling shoes. The receiving antenna is programmed to receive signals from the transmission zone (35) which as much as possible encircles the periphery of the rental space (15). Users and personnel must pass through an entry (34) to enter and leave the rental space (15) which is generally circular in form. It will be understood that by combining this particular geometry of the rental space (15) with the special design of the shoe (20) as described in FIG. 2b, the transmission signal from a shoe worn by a user outside the transmission zone (35) of the rental space (15) is no longer picked up by the receiving antenna (32). The invention proposes as an original feature a shoe equipped with an active RFID chip in continuous transmission. The loss of reception of the signal from said pair of shoes is thus interpreted by the software of the processing computer (33) as a rental of the shoe. In case of weak battery, the active RFID chip transmits another code which is interpreted by the software of the processing computer (33) as the shoe being out of service. In an improved version, if the shoe is declared new entering the stock or used and out of service, the authorized personnel can, in a first version, act directly on the processing software, or in a second version where the chip is equipped with another passive RFID chip, can act through a reader gantry to validate the change of status of the shoe.

The present invention thus concerns a tracking device for managing the rental of a stock of bowling shoes (20) for rent, stored inside a rental space (15) characterized in that at least one shoe (20) of each pair is equipped with an active RFID chip (21, 22, 23) supplied by a battery (22) which transmits to a receiving antenna (32), located inside the rental space (15), connected to the reader and the processing computer (33) of the rental space (15) in such a manner that the presence of the pairs of shoes is monitored in real time when they are not rented and in that it also comprises means for deactivating the transmission from the active RFID chips (21, 22, 23) and/or the reception by the receiving antenna (32) when the shoes are rented out in such a manner that the absence of rented pairs of shoes inside the rental space is continuously monitored.

The present invention thus concerns a tracking device for managing the rental of a stock of bowling shoes (20) characterized in that the active RFID chip (21, 22, 23) continuously transmits a UHF signal from its antenna (23).

The present invention thus concerns a tracking device for managing the rental of a stock of bowling shoes (20) characterized in that the active RFID chip (21, 22, 23) called active RFID tag is set at a frequency of 433 MHz with transmission about every second.

The present invention thus concerns a tracking device for managing the rental of a stock of bowling shoes (20) characterized in that the bowling shoe (20) houses in its heel (T) the active RFID chip unit (21, 22, 23); the invention seeks to channel all of the transmitted waves upward through the body of the user, and more specifically in his heel, with a shield (B) positioned in the active RFID chip heel [sic] to channel the waves upward.

The present invention thus concerns a tracking device for managing the rental of a stock of bowling shoes (20) characterized in that a contact switch (28) is housed in the sole (S) of the shoe (20), the function of which switch is to stop the transmission of the active RFID chip and/or to transmit another code when the foot is inside [sic] the sole (S).

The present invention thus concerns a tracking device for managing the rental of a stock of bowling shoes (20) characterized in that the storage space (30) of shoes of the rental space (15) is arranged in an arc of circle, with the receiving antenna (32) at its center.

The present invention thus concerns a tracking device for managing the rental of a stock of bowling shoes (20) characterized in that the receiving antenna is programmed to receive signals from a transmission zone (35) which as much as possible encircles the periphery of the rental space (15).

The present invention thus concerns a tracking device for managing the rental of a stock of bowling shoes (20) characterized in that another receiving antenna is placed in a specific location of the bowling alley to receive rental signals transmitted by the shoes to prevent their use in prohibited areas.

The present invention thus concerns a tracking device for managing the rental of a stock of bowling shoes (20) characterized in that a passive RFID chip is also positioned inside the shoe.

The present invention thus concerns a device for tracking rental management, characterized in that it applies to the rental of other sports items such as tennis rackets, golf clubs or ice skates.

The present invention thus concerns a tracking device for rental management, characterized in that it allows the tracking for the management of a stock of items for rent such as automobiles or mopeds or scooters.

It is clear that numerous variations that can possibly be combined can be made here without ever going beyond the scope of the invention as defined above.

1. A tracking device for managing the rental of a stock of bowling shoes comprising a stock of pairs of shoes intended for rent stored inside a rental space comprising at least one shoe of each pair of shoes is equipped with an active RFID chip supplied by a battery which transmits to a receiving antenna, located inside the rental space, connected to the reader and the processing computer of the rental space in such a manner that the presence of the pairs of shoes is monitored continuously when they are not rented and in that it also comprises means for deactivating the transmission from the active RFID chips and/or the reception by the receiving antenna when the shoes are rented out in such a manner that the absence of rented pairs of shoes inside the rental space is monitored in real time.

2. A tracking device for managing the rental of a stock of bowling shoes claim 1, wherein the active RFID chip continuously transmits a UHF signal from its antenna.

3. A tracking device for managing the rental of a stock of bowling shoes of claim 1, wherein the active RFID chip called active RFID tag is set at a frequency of 433 MHz or 868 MHz with transmission about every second.

4. A tracking device for managing the rental of a stock of bowling shoes of claim 1, wherein the bowling shoe houses in its heel (T) the active RFID chip unit and seeks to channel all of the transmitted waves upward through the body of the user.

5. A tracking device for managing the rental of a stock of bowling shoes of claim 1, wherein a contact switch is housed in the sole (S) of the shoe, the function of which switch is to stop the transmission of the active RFID chip when the foot is inside the shoe.

6. A tracking device for managing the rental of a stock of bowling shoes of claim 1, wherein a contact switch is housed in the sole (S) of the shoe, the function of which switch is to transmit a new code to the active RFID chip when the foot is inside the shoe.

7. A tracking device for managing the rental of a stock of bowling shoes of claim 1, wherein the receiving antenna is disposed in such a manner as to cover the storage space of the shoes in the rental space.

8. A tracking device for managing the rental of a stock of bowling shoes of claim 1, wherein the receiving antenna is programmed to receive signals from a transmission zone which as much as possible encircles the periphery of the rental space.

9. A tracking device for managing the rental of a stock of bowling shoes of claim 1, wherein another receiving antenna is placed in a specific location of the bowling alley to receive rental signals transmitted by the shoes to prevent their use in prohibited areas.

10. A tracking device for managing the rental of a stock of bowling shoes of claim 1, wherein a passive RFID chip is also positioned inside the shoe.

11. A tracking device for rental management of claim 1, wherein it applies to the rental of other sports items.

12. A tracking device for rental, management of claim 1, wherein it allows tracking for the management of a stock of items for rent selected from the group consisting of automobiles, mopeds and scooters.

13. The tracking device of claim 4 wherein the transmittable waves is passed with a shield (B) positioned in the head beneath the active RFID chip to change the waves upward.

14. The tracking device of claim 11 applied to sport items selected from the group consisting of tennis rackets, golf clubs and ice skates.
